(19) United States
(12) Patent Application Publication
(10) Pub. No.: US 2009/0280285 A1
(43) Pub. Date: Nov. 12, 2009

(54) STAMPER HOLDER, MOLDING DIE AND MOLDED SUBSTRATE FOR RECORDING MEDIUM

(75) Inventors: Shinobu Sugimura, Yokohama-shi (JP); Seiji Morita, Yokohama-shi (JP); Akiko Yuzawa, Yokohama-shi (JP); Masatoshi Sakurai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/463,270

(22) Filed: May 8, 2009

(30) Foreign Application Priority Data
May 12, 2008 (JP) 2008-125129

(51) Int. Cl. G11B 3/70

(52) U.S. Cl. 428/64.2; 425/287

(57) ABSTRACT

According to one embodiment, there is provided a stamper holder which holds a disk-shape metal stamper for molding having a center hole with an inner diameter of 17.5 mm or less and formed with patterns of protrusions and recesses for a recording medium on a surface in a state that the stamper holder is fixed to a first die having a center hole, in which the stamper holder has an approximately cylindrical shape so as to be inserted into the center hole of the first die and comprises a flange provided at one end configured to hold an inner peripheral portion of the stamper surface near the center hole, and an outer diameter of the flange is 17.6 mm or less.

### CROSS-REFERENCE TO RELATED APPLICATIONS

This application is based upon and claims the benefit of priority from Japanese Patent Application No. 2008-125129, filed May 12, 2008, the entire contents of which are incorporated herein by reference.

### BACKGROUND

1. Field

The present invention relates to a stamper holder holding a stamper to be used for manufacturing a molded substrate for a recording medium having patterns of protrusions and recesses by injection molding, a molding die including the stamper holder, and a molded substrate for a recording medium molded by using the molding die.

2. Description of the Related Art

In recent years, in order to improve recording density of magnetic recording media, discrete track recording media (DTR media) in which recording tracks are physically separated from each other are proposed.

The DTR media use an imprinting method, and are manufactured as follows. An imprint stamper with patterns of protrusions and recesses corresponding to the DTR medium is manufactured. On the other hand, a magnetic film is deposited on a medium substrate, and a resist is applied thereto. The imprint stamper is pressed against the resist applied to the medium substrate so that the patterns of protrusions and recesses are transferred to the resist, and a magnetic film is processed by using the resist as a mask.

Conventionally, a Ni stamper (a father stamper, a mother stamper or a son stamper) manufactured by an electroforming process has been used as the imprint stamper. When the electroforming process is used, however, it takes about one hour to manufacture one Ni stamper. On the contrary, when an original Ni stamper (father stamper) is manufactured by the electroforming process and thereafter a molded substrate (imprint stamper) is manufactured by using an injection molding process, it can be expected that one imprint stamper made of resin is manufactured in about several seconds.

In optical disks such as DVD (digital versatile disks) where two molded substrates are bonded, at least patterns of protrusions and recesses with a track pith of 300 nm or more is formed on one molded substrate, on which an optical recording layer with a thickness of 30 μm or more is deposited. When such an optical disks are manufactured, a molded substrate on which the pattern of the stamper is transferred by injection molding is used.

When a land-and-groove structure with a track pitch of 300 nm is formed on the molded substrate of the optical disk by injection molding, a height of burrs generated on boundary portions between a die for holding the stamper and the stamper should be controlled to 30 μm or less. Since the optical recording layer is sufficiently thick, the burrs are buried in the optical recording layer and thus the burrs do not become a problem in the bonding step.

A method has been proposed in which, in order to securely solve the problem of the burrs, a projected portion is provided on an inner peripheral portion of the die and a step higher than the recording area is formed on an inner peripheral portion of the stamper. When the projected portion of the die is fitted into a center hole of the stamper, the upper surface of the step of the stamper is flush with the upper surface of the projected portion of the die, and recesses are formed on an inner peripheral portion of the molded substrate by injection molding. In this method, since burrs are formed in the recesses of the molded substrate, the problem of the burrs can be solved (for example, see Jpn. Pat. Appln. KOKAI Publication No. 2004-310937).

However, when the molded substrate having the patterns of protrusions and recesses with a track pitch of 100 nm or less, which is fabricated by injection molding, is used as the imprint stamper and DTR media are manufactured, the above method for manufacturing optical disks causes a problem.

When the DTR media having the patterns of protrusions and recesses with a track pith of 100 nm or less are manufactured, it is preferable that a thickness of the resist applied to the magnetic layer deposited on the medium substrate is thinned to 100 nm or less. However, if projections or steps such as burrs are present on the surface of the molded substrate when the resist on the medium substrate and the molded substrate (imprint stamper) are pressed against each other, a gap is generated between the molded substrate and the resist, and thus the patterns of protrusions and recesses of the molded substrate cannot be transferred to the resist. Even if the recesses are formed on the inner peripheral portion of the molded substrate and burrs are generated in the recesses like Jpn. Pat. Appln. KOKAI Publication No. 2004-310937, the problem that the patterns of protrusions and recesses cannot be transferred to the resist does not be solved in the manufacturing of the DTR media where the patterns are transferred to the thin resist.

When a Ni stamper is held in a die, a stamper holder which holds the inner peripheral portion of the Ni stamper surface and whose holding portion is tapered is used (see Jpn. Pat. Appln. KOKAI Publication No. 10-128807). A punching method is generally adopted as a method for processing the inner periphery of the Ni stamper, and this stamper holder might be advantageous as a countermeasure against generation of a taper on the punched surface of the Ni stamper. That is, the taper of the holding portion of the stamper holder is fitted to the taper generated on the punched surface of the Ni stamper, so that the Ni stamper might be held with the upper surface of the stamper holder being approximately flush with the upper surface of the Ni stamper.

However, since the shape of the taper of the Ni stamper generated by punching greatly changes depending on a thickness and hardness of the Ni stamper, it is difficult to manufacture the stamper holder fitted accurately to the taper of the Ni stamper. A step is generated on the molded substrate unless both the tapers of the Ni stamper and the stamper holder are fitted accurately, and thus it is practically difficult to manufacture a molded substrate without a step. When the DTR medium having patterns of protrusions and recesses with a track pitch of 100 nm or less is manufactured, the presence of the step which forms a higher projection than that of the patterned surface on the molded substrate disables the patterns of protrusions and recesses to be transferred to the resist.

The inventors of the present invention studied that the inner peripheral portion of the Ni stamper surface is held down on the die by a stamper holder having a flange. In this case, the upper surface of the stamper holder having the flange is higher than the upper surface of the Ni stamper, so that a step which forms a recess corresponding to a thickness of the flange is generated on the inner peripheral portion of the molded substrate fabricated by injection molding. Therefore, the problem that the patterns of protrusions and recesses cannot be transferred to the resist due to the burrs or the steps which form the protrusions in imprinting can be solved.

However, when the injection molding is carried out with the step being present between the upper surface of the Ni stamper and the upper surface of the stamper holder having the flange in the above method, it is found that defects called flow marks are likely to occur on the inner peripheral portion of the molded substrate. The flow mark is a trace of flow which is generated in a direction perpendicular to the flowing direction of resin while molten resin is hardened because of slow flow. When the flow marks are generated, transfer properties of the patterns are deteriorated, and thus a countermeasure against the flow marks is necessary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A to 1C are cross-sectional views illustrating a method for manufacturing a molded substrate by injection molding using a molding die including a stamper holder according to the present invention;

FIG. 2 is a cross-sectional view illustrating a state that a Ni stamper is held by the stamper holder having a flange according to the present invention;

FIG. 3 is a cross-sectional view illustrating a state that the Ni stamper is held by the stamper holder having a taper;

FIG. 4 is a cross-sectional view illustrating a step of punching a center hole of the Ni stamper using a punching blade;

FIGS. 5A and 5B are cross-sectional views illustrating problems in the case where the Ni stamper is held by the stamper holder having the taper;

FIGS. 6A and 6B are cross-sectional views illustrating problems in the case where an imprint step of a DTR medium is performed by using the molded substrate formed with a step forming protrusions on an inner peripheral portion;

FIGS. 7A and 7B are a plan view and a cross-sectional view of the molded substrate formed with a untransferred portion;

FIGS. 8A to 8E are cross-sectional views illustrating a method for manufacturing a magnetic recording medium (DTR medium) where the molded substrate of the present invention is used as an imprint stamper; and

FIGS. 9A and 9B are plan views illustrating the molded substrate where patterns of protrusions and recesses can be transferred to the entire surface thereof, and the molded substrate where an untransferred area is generated on the inner peripheral portion thereof.

### DETAILED DESCRIPTION

Various embodiments according to the invention will be described hereinafter with reference to the accompanying drawings. In general, according to one embodiment of the invention, there is provided a stamper holder which holds a disk-shape metal stamper for molding having a center hole with an inner diameter of 17.5 mm or less and formed with patterns of protrusions and recesses for a recording medium on a surface in a state that the stamper holder is fixed to a first die having a center hole, wherein the stamper holder has an approximately cylindrical shape so as to be inserted into the center hole of the first die and comprises a flange provided at one end configured to hold an inner peripheral portion of the stamper surface near the center hole, an outer diameter of the flange being 17.6 mm or less.

According to another embodiment of the invention, there is provided a die apparatus comprising: a first die having a center hole to which a disk-shape metal stamper for molding having a center hole with an inner diameter of 17.5 mm or less and formed with patterns of protrusions and recesses for a recording medium on the surface thereof is fixed; a stamper holder which has an approximately cylindrical shape so as to be inserted into the center hole of the first die and is provided with a flange configured to hold an inner peripheral portion of the stamper surface near the center hole at one end thereof, an outer diameter of the flange being 17.6 mm or less; a sprue bush arranged in the stamper holder; and a second die arranged so as to be opposed to the first die to which the metal stamper is fixed and forms a cavity to be filled with molten resin.

According to still another embodiment of the invention, there is provided a molded substrate for a recording medium with a disk shape having a center hole and comprising a recording area formed with patterns of protrusions and recesses on the surface thereof, wherein the molded substrate comprises a step formed on a position inward by 0.5 mm or more from an innermost peripheral position of the recording area. It is preferable that, in the molded substrate, a diameter of the position where the step is formed be 17.6 mm or less.

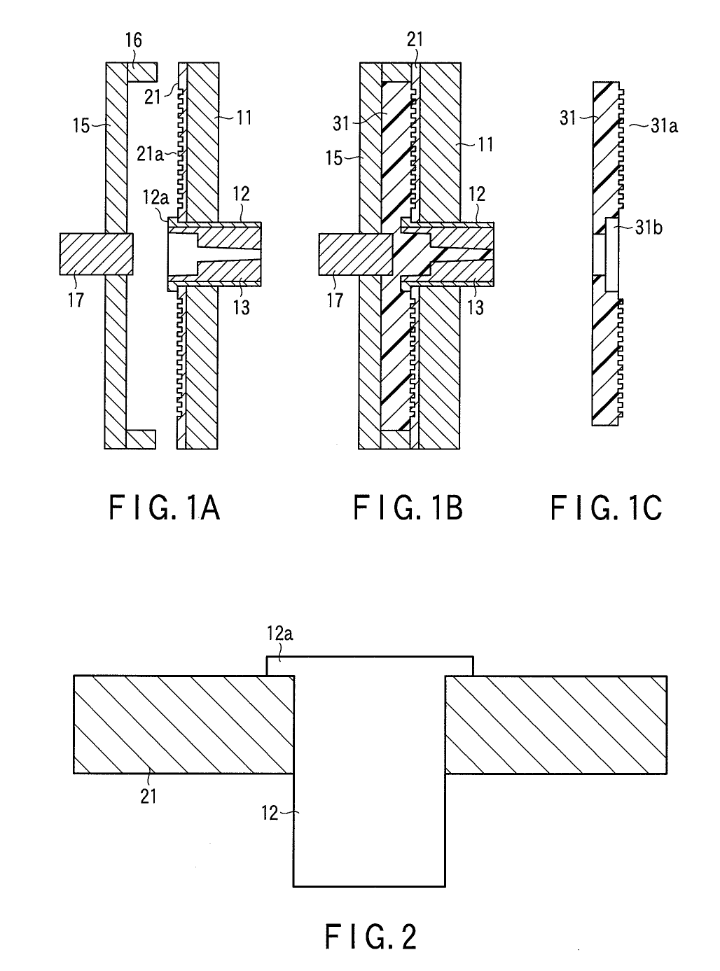

A method of manufacturing a doughnut-shape molded substrate (imprint stamper) for a recording medium by injection molding using a molding die including a stamper holder according to the present invention will be described below with reference to FIGS. 1A to 1C.

As shown in FIG. 1A, a fixed die (first die) 11 and a movable die (second die) 15 are arranged in an injection molding machine, not shown, so as to be opposed to each other and capable of being closer to and separated from each other.

A doughnut-shape Ni stamper 21 is placed on the fixed die 11 having a center hole. The Ni stamper 21 has a center hole with inner diameter of 17.5 mm or less and is formed with patterns of protrusions and recesses 21a for a recording medium on the surface thereof. At this time, the patterns of protrusions and recesses face the movable die 15. The Ni stamper 21 is manufactured by applying a resist to a master, carrying out electron lithography and carrying out electroforming according to a common method. A cylindrical stamper holder 12 is inserted into the center hole of the fixed die 11 so as to fix the Ni stamper 21. The stamper holder 12 has a flange 12a at one end thereof, the flange 12a holds an inner peripheral portion of the Ni stamper 21 surface near the center hole, an outer diameter of the flange 12a being 17.6 mm or less. An innermost peripheral position of a recording area formed with the patterns of protrusions and recesses on the fixed die 11 is separated by 0.5 mm or more from an outer peripheral position of the flange 12a of the stamper holder 12. A sprue bush 13 is mounted to the stamper holder 12, through which molten resin is injected. A cavity ring 16 is provided to an outer periphery of the movable die 15. A cut punch 17 which punches the center hole of a molded substrate is provided at a center of the movable die 15.

As shown in FIG. 1B, the fixed die 11 and the movable die 15 are clamped. The cavity ring 16 of the movable die 15 comes in contact with the surface of the Ni stamper 21 on the fixed die 11 on the outer side with respect to the outermost peripheral position of the patterns of the recording area, and a cavity to be filled with molten resin is formed between the Ni stamper 21 and the movable die 15. A thickness of the molded substrate manufactured by injection molding is determined by an interval between the surface of the Ni stamper 21 and the surface of the movable die 15 when both are clamped. The surface of the movable die 15 defines a rear surface of the molded substrate. An outer diameter of the molded substrate is determined by a position of the cavity ring 16 in contact with the Ni stamper 21. In this state, the molten resin is injected through the sprue bush 13 into the cavity, and approximately at the same time, the cut punch 17 is protruded from the movable die 15 towards the fixed die 11 so that a center hole of the molded substrate is formed. Thereafter, the injected molten resin is cooled to a die temperature so as to be solidified.

The resin to be used in the present invention is not particularly limited, but polycarbonate or cyclic polyolefin is suitable.

As shown in FIG. 1C, the movable die 15 is removed, and the solidified resin is separated from the Ni stamper 21 so that a doughnut-shape molded substrate 31 is manufactured. The molded substrate 31 has a recording area formed with patterns of protrusions and recesses 31a corresponding to the Ni stamper 21 on the surface thereof, and a step 31b which forms a recess formed on a position separated inward by 0.5 mm or more from the innermost peripheral position of the recording area. That is, an upper surface of the step 31b is lower than an upper surface of the patterns of protrusions and recesses 31a. A diameter of the position formed with the step 31b is 17.6 mm or less.

A shape of the stamper holder will be described.

In the present invention, as shown in FIG. 2, the cylindrical stamper holder 12, which is provided with the flange 12a for holding the inner peripheral portion of the Ni stamper 21 surface near the center hole at one end thereof, is used.

When the molded substrate 31 is injection-molded while being held down by the flange 12a of the stamper holder 12 for holding the inner peripheral portion of the Ni stamper 21 surface near the center hole, the step 31b which forms the recess is formed on the inner peripheral portion of the molded substrate 31 correspondingly to the step between the Ni stamper 21 surface and the flange 12a.

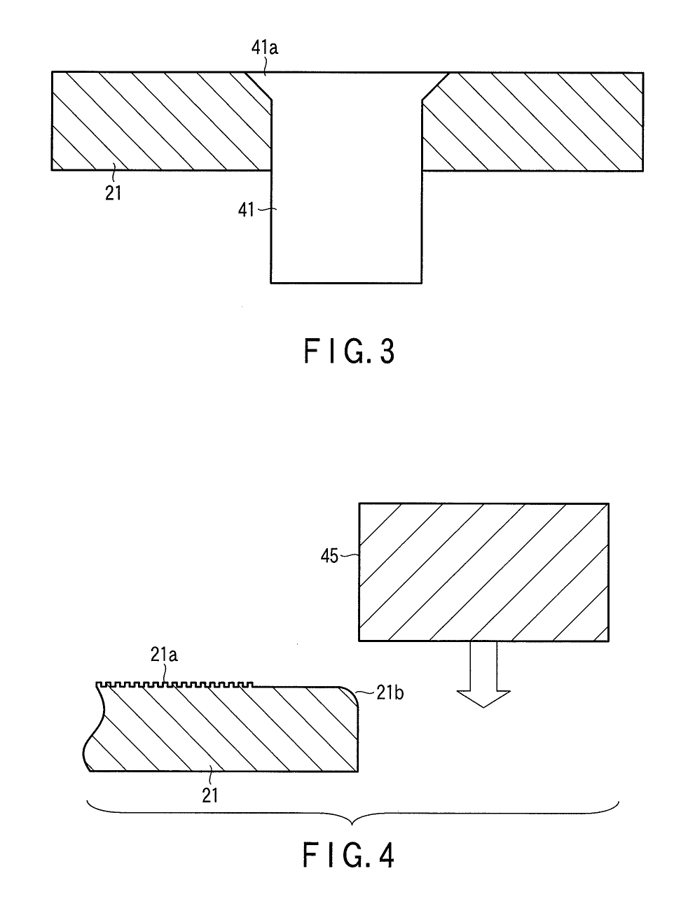

On the other hand, in patent document 2, as shown in FIG. 3, a cylindrical stamper holder 41, which is formed with a taper 41a for holding the inner peripheral portion of the surface of the Ni stamper 21 near the center hole at one end thereof, is used. This shape has a purpose to make the upper surface of the stamper holder 41 and the upper surface of the stamper 21 approximately flush with each other.

As shown in FIG. 4, however, a shape of a taper 21b of the Ni stamper 21 generated at the time of punching the center hole of the Ni stamper 21 using a punching blade 45 greatly changes depending on thickness and hardness of the Ni stamper 21. Thus, it is difficult to manufacture the stamper holder 41 accurately fitted to the taper 21b of the Ni stamper 21.

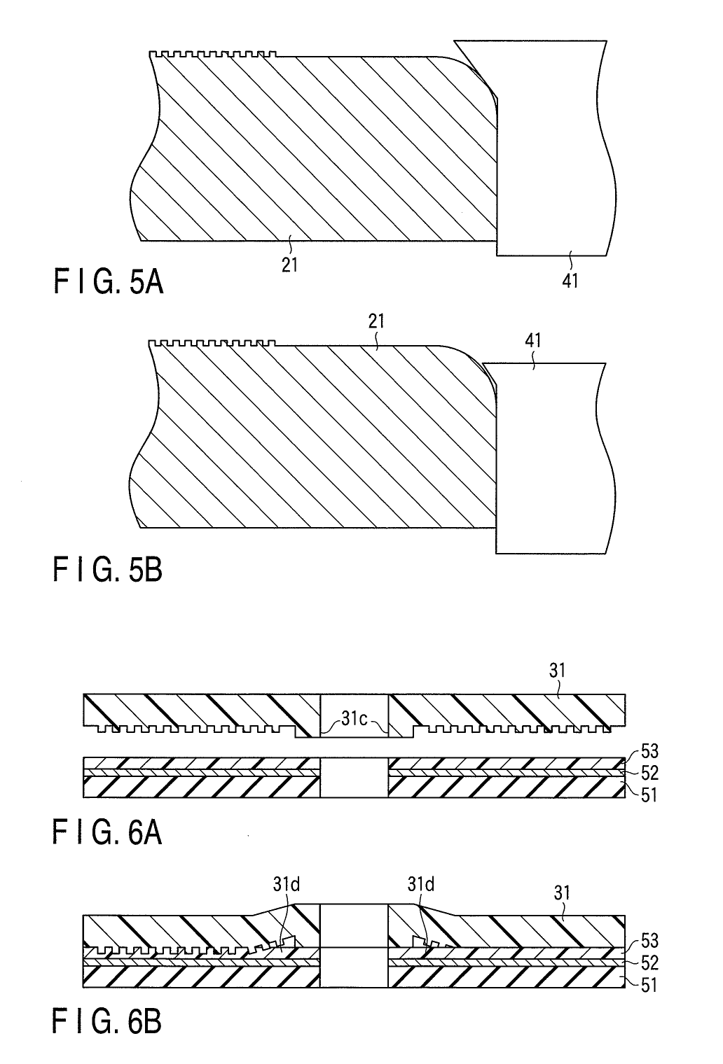

For this reason, the upper surface of the stamper holder 41 may occasionally be higher than the upper surface of the stamper 21 as shown in FIG. 5A, or the upper surface of the stamper holder 41 may occasionally be lower than the upper surface of the stamper 21 as shown in FIG. 5B. When the upper surface of the stamper holder 41 is lower than the upper surface of the stamper 21 as shown in FIG. 5B, a step which forms a protrusion corresponding to that step is formed on the inner peripheral portion of the molded substrate 31.

When a step of imprinting a DTR medium is performed by using the molded substrate 31 formed with a step 31c forming the protrusions on the inner peripheral portion thereof, the patterns cannot be transferred. This problem will be described with reference to FIGS. 6A and 6B.

As shown in FIG. 6A, in the step of imprinting a DTR medium, a magnetic film 52 is deposited on a medium substrate 51, and a resist 53 with film thickness of 100 nm or less is applied thereto. The molded substrate (imprint stamper) 31 formed with the step 31c forming the protrusions on the inner peripheral surface thereof is opposed to the resist 53.

As shown in FIG. 6B, in order to transfer the patterns of the molded substrate 31, the molded substrate 31 is pressed against the resist 53 on the medium substrate 51. However, when the inner peripheral portion of the molded substrate 31 is formed with the step 31c protruded from the upper surface of the patterns of protrusions and recesses of the recording area, the patterns near the step 31c are lifted from the surface of the resist 53, so that an untransferred portion 31d where the patterns cannot be transferred is generated.

In the present invention, the step 31b which forms the recess is formed on the inner peripheral portion of the molded substrate 31 correspondingly to the step between the surface of the Ni stamper 21 and the flange 12a. Thus, defective pattern transfer caused by the step 31c forming the patterns of protrusions and recesses will not be caused.

When the inner peripheral portion of the surface of the Ni stamper 21 near the center hole which is not much separated from the innermost peripheral position of the patterns of protrusions and recesses of the recording area of the Ni stamper 21 is held by the flange 12a of the stamper holder 12, flow marks are occasionally generated on the step of the flange 12a at the time of injection molding.

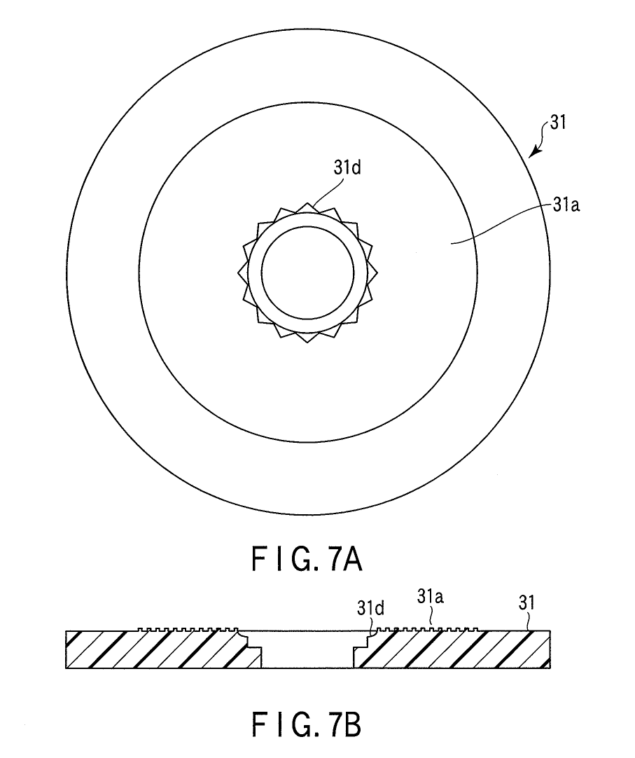

As shown in FIGS. 7A and 7B, defective fine pattern transfer occurs on the inner peripheral portion of the molded substrate 31 where the flow marks are generated, so that the untransferred portion 31d is formed.

On the contrary, in the present invention, a distance from the innermost peripheral position of the patterns of protrusions and recesses on the recording area of the Ni stamper 21 to the outer periphery of the flange 12a of the stamper holder 12 is spaced by 0.5 mm or more. Further, the step 31b which forms the recess is formed on the position separated inward by 0.5 mm or more from the innermost peripheral position on the recording area of the molded substrate 31. As a result, an influence of flow marks is avoided, and satisfactory transfer properties are provided on the entire surface of the molded substrate 31.

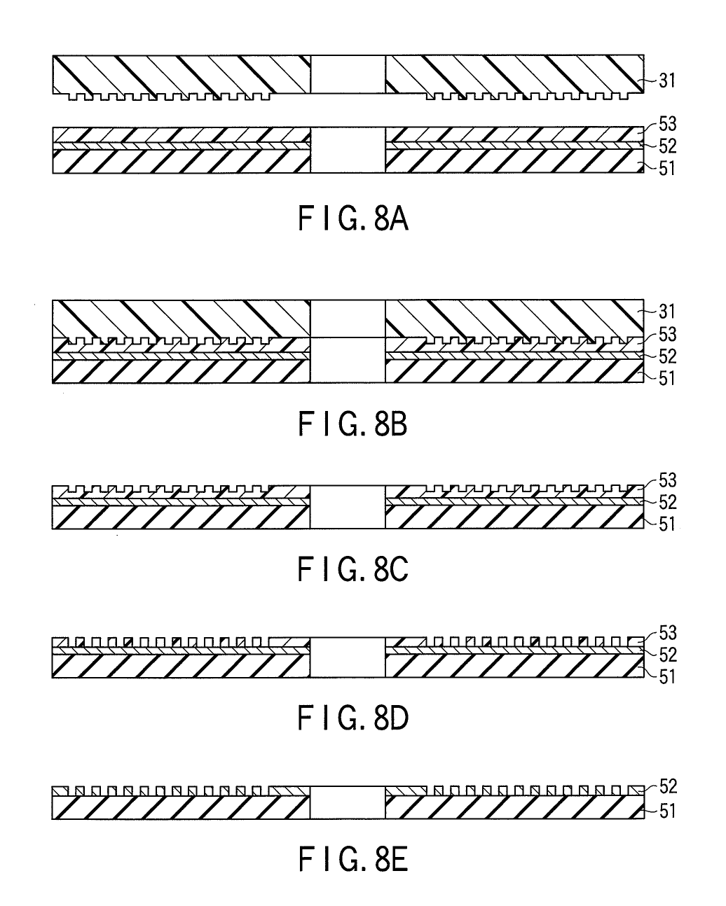

A method for manufacturing a magnetic recording medium (DTR medium) using the molded substrate 31 as the imprint stamper will be described below with reference to FIGS. 8A to 8E.

As shown in FIG. 8A, the magnetic film 52 is deposited on the medium substrate 51, and the resist 53 with a film thickness of 100 nm or less is applied thereto. The molded substrate (imprint stamper) 31 is opposed to the resist 53.

As shown in FIG. 8B, in order to transfer the patterns of the molded substrate 31, the molded substrate 31 is pressed against the resist 53 on the medium substrate 51.

As shown in FIG. 8C, the molded substrate 31 is peeled off. The patterns of protrusions and recesses transferred from the molded substrate 31 are formed on the recording area surface of the resist 53.

As shown in FIG. 8D, resist residues remained in the recesses of the patterns of protrusions and recesses of the resist 53 is removed, so that the surface of the magnetic film 52 is exposed.

As shown in FIG. 8E, the magnetic film 52 is processed by milling using the patterned resist 53 as a mask, so that desired magnetic patterns are provided.

Thereafter, the recesses between the magnetic patterns are filled with non-magnetic material as needed, and a DLC protective film is formed on the surface of the magnetic pattern. A lubricant is applied to provide a magnetic recording medium (DTR medium).

EXAMPLES

Examples of the present invention will be described below.

### Example 1

Specifications of the DTR medium to be manufactured are as follows. Magnetic patterns are formed with a track pitch of 74 nm on the recording area on the medium substrate having diameter of 1.8 inches within a range of 9.3 mm to 22.3 mm on a radial position. The magnetic patterns on a track zone have a land width of 52 nm and a groove width of 26 nm. The shapes of the magnetic patterns on the servo zones are as usual.

Specifications of the Ni stamper to be used for injection molding are as follows. The Ni stamper is manufactured by using electron lithography and electroforming according to a common method. The Ni stamper has an outer diameter of 65.00 mm, an inner diameter of 17.50 mm and a thickness of 0.290 mm. The Ni stamper has the patterns of protrusions and recesses corresponding to the magnetic patterns of the DTR medium. A height of the patterns is 50 nm.

Specifications of the stamper holder to be used for injection molding are as follows. The flange has an outer diameter of φ17.60 mm, stamper clamping allowance of 50 μm and a height of 10 μm.

On the other hand, an outer diameter of the cut punch mounted on the movable die is φ12.05 mm.

The Ni stamper is placed on the fixed die and is held by the stamper holder so as to be injection-molded as follows. That is, the cavity formed by the fixed die and the movable die is filled with molten resin through the sprue bush, and approximately simultaneously they are pressurized and cooled, so that the molded substrate having the same structure as the cavity is manufactured. The conditions of the injection molding are as follows:

Resin material for injection molding: cyclic polyolefin (COP: ZEONOR-1060R made by Zeon Corporation), temperature of the molten resin: 370° C., the die temperature: 100° C., clamping force: 50 t, cooling time: 80 sec., and molding cycle: 10 sec.

### Example 2

A molded substrate was manufactured in the same manner as Example 1 except that the inner diameter of the Ni stamper was 17.00 mm and the outer diameter of the flange of the stamper holder was φ17.10 mm.

### COMPARATIVE EXAMPLE

A molded substrate was manufactured in the same manner as Example 1 except that the diameter of the flange of the stamper holder was φ17.70 mm.

The specifications of the molded substrate manufactured in the above manner are as follows. The material is COP (ZEONOR-1060R), the outer diameter is 58 mm, the inner diameter is 12 mm, and the thickness is 0.6 mm. A step which forms a recess of 10 μm is present on the inner peripheral portion of the molded substrate surface in any of Examples 1 and 2 and Comparative Example. The rear surface of the molded substrate is flat.

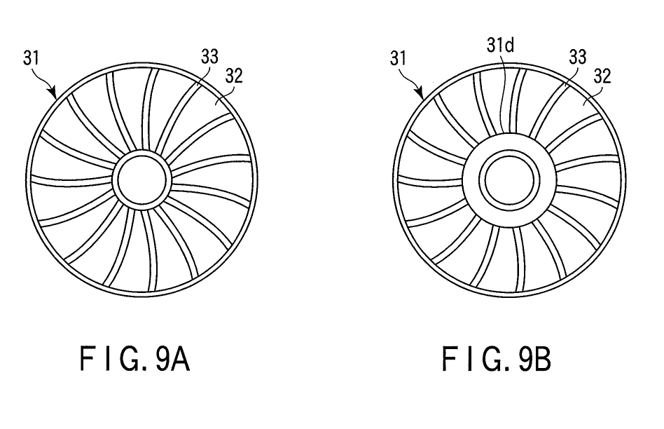

100 molded substrates were manufactured by each method in Examples 1 and 2 and Comparative Example, and the patterned surfaces of the obtained molded substrates were observed with an OSA. FIGS. 9A and 9B show observed results of the molded substrates. Track zones 32 and servo zones 33 are formed alternately along the peripheral direction on the surface of the molded substrate 31.

FIG. 9A illustrates the molded substrate 31 where the transfer of the pattern to the inner periphery can be confirmed and the patterns of protrusions and recesses can be transferred to the entire surface. FIG. 9B illustrates the molded substrate 31 where the untransferred area 31d due to influence of flow marks is formed on the inner periphery. In the respective examples, the number of the molded substrates 31 with the untransferred area 31d was checked, and maximum outer diameter of the untransferred area 31d was measured. The results will be described below.

In Example 1, 95 molded substrates where the patterns were transferred to the entire surface and five molded substrates having untransferred area were obtained, and the maximum outer diameter of the untransferred area was 18.9 mm.

In Example 2, the patterns were transferred to the entire surfaces of all the molded substrates.

In Comparative Example 1, 72 molded substrates where the patterns were transferred to the entire surface and 28 molded substrates having untransferred area were obtained, and the maximum outer diameter of the untransferred area was 20.8 mm.

According to these results, in order to manufacture the molded substrates without untransferred area efficiently with good yield of 90% or more, it is preferable that the outer diameter of the flange of the stamper holder is set to 17.6 mm or less and the distance from the innermost peripheral position of the patterns of protrusions and recesses on the recording area of the Ni stamper to the outer periphery of the stamper holder is set to 0.5 mm or more.

A method of manufacturing a DTR medium using the molded substrate where the patterns are transferred to the entire surface as the imprint stamper will be described.

A magnetic film with thickness of 15 nm is formed on a medium substrate, and the magnetic film is spin-coated with a UV curing resist with thickness of 50 μm. A patterned surface of a molded substrate is pressed against the resist of the medium substrate in an opposed manner. When the molded substrate is peeled off, the patterns of protrusions and recesses transferred from the molded substrate are formed on the surface of the recording area of the resist. A height of the formed patterns of protrusions is 50 nm. The resist is etched by 20 nm by oxygen RIE, and resist residues remained in the recesses of the resist are removed, so that the surface of the magnetic film is exposed. As a result, the height of the patterns of protrusions and recesses becomes 40 nm. The magnetic film exposed in the recesses of the resist is removed by 10 nm according to Ar ion milling, so that magnetic patterns are provided. After DLC of 5 nm is deposited on the surface of the magnetic pattern, a lubricant is applied thereto so that the DTR medium is provided.

The molded substrate manufactured by using the stamper holder and the molding apparatus of the present invention is used as the imprint stamper, so that the patterns can be transferred to the entire surface of the resist applied to the medium substrate surface. As a result, the DTR medium capable of reading and writing on the entire surface and a magnetic recording apparatus mounted with the DTR medium can be manufactured. Therefore, the production efficiency of the DTR medium and the magnetic recording apparatus can be improved by taking an advantage of the injection molding in which the imprint stamper (molded substrate) can be manufactured at a speed of about 10 seconds per one substrate.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stamper holder configured to hold a disk-shape metal stamper for molding comprising a center hole with an inner diameter of 17.5 mm or shorter and patterns of concavity and convexity for a recording medium on a surface in such a manner that the stamper holder is attached to a first die comprising a center hole,
wherein the stamper holder comprises an approximately cylindrical shape and is configured to be inserted into the center hole of the first die and comprises a flange at a first end configured to hold an inner peripheral portion of the stamper surface near the center hole, an outer diameter of the flange being 17.6 mm or shorter.

2. A die apparatus comprising:
a first die comprising a center hole configured to attach to a disk-shape metal stamper for molding comprising a center hole with an inner diameter of 17.5 mm or shorter and patterns of concavity and convexity for a recording medium on the surface of the stamper;
a stamper holder which comprises an approximately cylindrical shape and is configured to be inserted into the center hole of the first die with a flange configured to hold an inner peripheral portion of the stamper surface near the center hole at a first end of the stamper holder, an outer diameter of the flange being 17.6 mm or shorter;
a sprue bush in the stamper holder; and
a second die opposite to the first die with the metal stamper attached comprising a cavity configured to comprise molten resin.

3. A molded substrate for a recording medium of a disk shape with a center hole comprising a recording area comprising patterns of concavity and convexity on the surface of the molded substrate, wherein the molded substrate comprises a step on a position inward by 0.5 mm or longer from an innermost peripheral position of the recording area.

4. The molded substrate for a recording medium of claim 3, wherein a diameter of the position of the step is 17.6 mm or shorter.

5. The molded substrate for a recording medium of claim 3, wherein an upper surface of the step is lower than an upper surface of the patterns of concavity and convexity.
